(19) United States
(12) Patent Application Publication
(10) Pub. No.: US 2006/0223662 A1
(43) Pub. Date: Oct. 5, 2006

(54) Alternator for vehicles

(75) Inventors: Kouichi Ihata, Okazaki-shi (JP); Tsutomu Shiga, Nukata-gun (JP); Atsushi Umeda, Okazaki-shi (JP)

Correspondence Address: OLIFF & BERRIDGE, PLC, P.O. BOX 19928, ALEXANDRIA, VA, 22320, US

(73) Assignee: DENSO CORPORATION, Kariya-city (JP)

(21) Appl. No.: 11/392,662

(22) Filed: Mar. 30, 2006

(30) Foreign Application Priority Data
Mar. 31, 2005 (JP) 2005-100917

(51) Int. Cl. F16H 7/12; F16H 61/00

(52) U.S. Cl. 474/135; 474/87; 474/70

(57) ABSTRACT

In an on-vehicle alternator using a serpentine drive system with a poly-V belt, a damping ratio of the alternator is rendered 0.5 or more as other auxiliary machines by considering six contributors to the damping ratio (i.e., pulley radii, a belt span, a moment of inertia, the number of belt ribs, an elasticity modulus of a single-body belt, and a hysteresis loss of a single-body belt). In one example, a pulley ratio of the alternator relative to an engine crankshaft pulley is rendered 2 or less. In another example, belt span lengths on both sides of the alternator are reduced by fixing the alternator to an on-vehicle engine using a side mounting system. The damping ratio of the alternator is thus increased to 0.5 or more, leading to a significant reduction in vibration in the serpentine drive system fixed to the on-vehicle engine.

### CROSS-REFERENCE TO RELATED APPLICATION

This application is based on and claims the benefit of priority from earlier Japanese Patent Application No. 2005-100917 filed on Mar. 31, 2005, the description of which is incorporated herein by reference.

### BACKGROUND OF THE INVENTION

1. Technical field of the Invention

The present invention relates to alternators (i.e., AC generators) which can be mounted on vehicles such as passenger cars and trucks, and, in particular, to such alternators each assembled with an on-vehicle internal combustion engine as part of a serpentine drive system.

2. Related Art

Recently, there is a trend of employing a serpentine drive system as a drive system for auxiliary machines for a vehicle, such as an alternator (hereinafter simply referred to as an “alternator”). This drive system is to allow a single poly-V belt to wrap and drive all pulleys of auxiliary machines, such an alternator, as well as an air conditioner, a water pump and a power steering, together with a crankshaft pulley located at a crankshaft of an engine, so that workability at the time of mounting them is improved.

In such an auxiliary machinery system driven by a poly-V belt, it is known that an unstable behavior of an auxiliary machine having a large moment of inertia causes instability in engine operations. In the auxiliary machinery system for engine, the alternator particularly has a large inertia, and its pulley ratio with respect to the crankshaft pulley is high. Thus, the inertia of the alternator holds the key of amplifying the so rotational fluctuation. Since the stabilization in the rotation of the alternator leads to the stability of the engine rotation, the investigation is now underway.

One approach that has been taken for suppressing rotational fluctuation is to apply a theory of suppressing vibration. FIG. 6 shows the frequency (number of revolutions) responses of an engine main unit and each of the auxiliary machines (an alternator Alt, an air conditioner A/C, a water pump W/P and a power steering P/S) during engine rotation. As shown in the figure, the alternator has the highest compliance with respect to the number of revolutions (rpm) (vibrational magnification (rad/Nm)) during engine operation (rad/Nm=X(displacement)/F(force)), in comparison with other auxiliary machines (A/C, W/P and P/S). Suppression of this vibration enables the suppression of the rotational fluctuation.

For example, with the substitution of the rotational fluctuation by vibration, an idea of removing the causes of the vibration, that is, an idea of vibration isolation as means for suppressing the vibration is underway. Based on this idea, methods for reducing the influence of the moment of inertia of such an alternator have been suggested and are beginning to take shape by providing a one-way clutch at the pulley of an alternator (see Japanese Unexamined Patent Application Publication No. 61-228153), or providing a damper pulley via a spring (see Japanese Unexamined Patent Application Publication No. 2001-523325).

These measures of adding a clutch or a damper pulley to the pulley of an alternator may, however, create a problem of breaking the clutch or the damper pulley. The worst case would be that the alternator may operate at an idling condition and is likely to cause defective power generation.

Moreover, use of special components, such as a clutch and a damper pulley, has made the structure itself complicated, and increased the number of parts, thereby also causing a problem of cost increase.

### SUMMARY OF THE INVENTION

The present invention has been made to resolve the problems described above and has an object of providing an alternator which enables a reduction in vibration without using the special components, such as a clutch or a damper pulley.

In order to achieve the above object, the inventors investigated the factors that make the vibrational magnification of the alternator most prominent among all the auxiliary machines. In the investigation, the inventors focused on a damping ratio ζ, and conducted the studies provided below.

FIG. 7 is a graph showing a relation between the damping ratio ζ and the vibrational magnification (the graph may also referred to as a forced vibration response curve), which has been cited from a publicly known literature (for example, refer to a “handbook” written by Tokita et al. and published by Fujitec Corporation in Tokyo, Japan in 1987). In the graph, the vertical axis indicates a vibrational magnification X/X₁ (X-displacement, and X₁=static displacement P/k (k=spring constant) applied with a static force P), and the horizontal axis indicates a frequency ratio ω/ω₀ (X-frequency, and ω₀=characteristic frequency). The graph shows the variation of the vibrational magnification relative to the frequency ratio, when the damping ratio ζ is 0, 0.05, 0.10, 0.15, 0.25, 0.375, 0.50 and 1.0 (ζ=C/C_{c}(C=viscosity damping coefficient, and C_{c}=critical viscosity coefficient)).

As can be seen from FIG. 7, as the value of the damping ratio ζ decreases from 1.0 to 0, the vibrational magnification increases, resulting in high vibration.

The damping ratio ζ as mentioned above can be generally expressed by the following relation:

$$ζ = \frac{C}{\sqrt{J * K}} , \qquad ( 1 )$$

where J is a moment of inertia, K is a spring constant and C is a viscosity coefficient.

When the relation of the damping ratio ζ expressed by the above formula (1) is substituted by a drive relation of a vehicle, the following formula can be established:

$$ζ = \frac{{C}_{torsion}}{\sqrt{J * {K}_{torsion}}} , \qquad ( 2 )$$

where Kₜₒᵣₛᵢₒₙ is a spring constant and Cₜₒᵣₛᵢₒₙ is an equivalent viscosity damping coefficient.

The Kₜₒᵣₛᵢₒₙ (spring constant) and the Cₜₒᵣₛᵢₒₙ (equivalent viscosity damping coefficient) in the above formula (2) are generally known physical properties at the time when the auxiliary machines are actually mounted on a vehicle (this condition is hereinafter referred to as a “vehicle-mounted” condition).

The inventors determined the relation between the physical properties in the vehicle-mounted condition, and a Kₜₑₙₛᵢₗₑ that is the spring constant and a Cₜₑₙₛᵢₗₑ that is the equivalent viscosity damping coefficient in a single-body belt, and clarified the degree of contribution of the relation to the damping ratio ζ.

FIG. 8 shows the Kₜₑₙₛᵢₗₑ (spring constant) and the Cₜₑₙₛᵢₗₑ (equivalent viscosity damping coefficient) in the single-body belt. FIG. 9 shows the Kₜₒᵣₛᵢₒₙ (spring constant) and the Cₜₒᵣₛᵢₒₙ (equivalent viscosity damping coefficient) under the vehicle-mounted condition.

Relation of the Kₜₒᵣₛᵢₒₙ (spring constant) and the Cₜₒᵣₛᵢₒₙ (equivalent viscosity damping coefficient), which are the physical properties in the vehicle-mounted condition, with the Kₜₑₙₛᵢₗₑ (spring constant) and the Cₜₑₙₛᵢₗₑ (equivalent viscosity damping coefficient) in the single-body belt, is expressed by the following formulae (3) and (4).

$$\begin{matrix}{K}_{tortion} = {K}_{tensile} * {R}^{2} = ( E * A ) * \frac{Z}{L} * {R}^{2} & ( 3 ) \\ {C}_{tortion} = {C}_{tensile} * {R}^{2} = ( \frac{\frac{Δ E}{2} * A}{π * ϖ} ) * \frac{Z}{L} * {R}^{2} & ( 4 )\end{matrix}$$

By substituting the formulae (3) and (4) into the formula (2), the following formula (5) can be obtained.

$$\begin{matrix}ζ = \frac{{C}_{torsion}}{\sqrt{J * {K}_{torsion}}} \\ = \frac{{C}_{tensile} * R 2}{\sqrt{J * {K}_{tensile} * R 2}} \\ = \frac{( A * E ) * {R}^{2} * \frac{Z}{L}}{\sqrt{J * ( \frac{A * Δ E}{2 * π * ϖ} ) * {R}^{2} * \frac{Z}{L}}} \\ = \frac{( A * E ) * {R}^{2} * \frac{\sqrt{Z}}{\sqrt{L}}}{\sqrt{J * ( \frac{A * Δ E}{2 * π * ϖ} )}} ,\end{matrix} \qquad ( 5 )$$

where ω is frequency, J is a moment of inertia of each auxiliary machine, Kₜₒᵣₛᵢₒₙ is a combined spring constant of a belt at both sides of each auxiliary machine, Cₜₒᵣₛᵢₒₙ is a combined equivalent viscosity damping coefficient of a belt at both sides of each auxiliary machine, Kₜₑₙₛᵢₗₑ is a spring constant of the single-body belt, Cₜₑₙₛᵢₗₑ is an equivalent viscosity damping coefficient of the single-body belt, L is a combined span length of a belt at both sides of each auxiliary machine, R is a radius of a pulley of each auxiliary machine, Z is the number of ribs of the poly-V belt, E*A is an elasticity modulus of the single-body belt per rib, and ΔE/2 is a hysteresis loss (viscosity) of a belt per rib.

Six factors included in the formula (5) and contributing (6 contributors) to the damping ratio ζ and their degrees of contribution are described below.

The damping ratio ζ is: 1) in proportion to the pulley radius R, 2) in reverse proportion to the square root of the belt span L, 3) in reverse proportion to the square root of the moment of inertia J, 4) in proportion to the square root of the number of ribs Z of the belt, 5) in proportion to the elasticity modulus E*A of the single-body belt, and 6) in reverse proportion to the hysteresis loss ΔE/2*A of the single-body belt.

FIG. 10 shows the damping ratio ζ, which has been determined by the above formula (5), of each of the auxiliary machines, i.e. the alternator, as well as the air conditioner A/C, the water pump WIP, the power steering P/S, auto tensioner A/T and an idler. The damping ratio ζ in FIG. 10 indicates the calculated values when three different types of engines (E/G1, E/G2 and E/G3) are used.

As can be seen from FIG. 10, whichever of the engines is used, the damping ratio ζ of the alternator is less than 0.5, and the damping ratio ζ of other auxiliary machines is equal to or more than 0.5. Specifically, the damping ratio ζ of the alternator is significantly lower than those of other auxiliary machines, reflecting the real circumstances.

In line with the above results and the historical measures (mounting of a clutch pulley on an alternator) that have been taken, a principal feature of the present invention is to increase the damping ratio ζ of the alternator up to 0.5 or more, the level of the other auxiliary machines. Such an increase of the damping ratio ζ of the alternator up to 0.5 or more than, can lead to significant suppression of the vibration of a drive system.

Resolution for raising the damping ratio ζ of the alternator up to 0.5 or more is to consider the above 6 contributors as a whole, these contributors being pulley radii, a belt span, a moment of inertia, the number of belt ribs, an elasticity modulus of a single-body belt, and a hysteresis loss of a single-body belt.

In the present invention, a ratio of the pulley of the alternator relative to an engine crankshaft pulley may be 2 or less. This typically allows the effective diameter of the alternator to be Φ100 or more, by which the damping ratio ζ of the alternator can be improved, ensuring the damping ratio ζ of the alternator to be 0.5 or more in most vehicles.

In the present invention, a side-mounted system may be used to directly fix the alternator to the engine. This may allow the alternator to be close to the engine main unit, whereby the length of the belt span on both sides of the alternator can be reduced for improvement of the damping ratio.

FIG. 11 is a graph showing a vibrational magnification (rad/Nm) of the individual auxiliary machines (alternator Alt, air conditioner A/C, water pump W/P, and power steering P/S) during engine rotation, provided that the damping ratio G of the alternator is rendered 0.5 or more, the pulley ratio of the alternator relative to the engine crankshaft pulley is rendered 2 or less, and the side mounting system is used for fixing the alternator. As can be seen from the graph, it has been confirmed that the compliance (vibrational magnification) of the alternator with respect to the number of revolutions (rpm) during engine rotation is substantially at the same level as those of other auxiliary machines (A/C, W/P and P/S).

In the present invention, the relationship of the spring constant and equivalent viscosity damping coefficient of a core wire of the poly-V belt, i.e. the essential physical properties thereof, with respect to those of polyester (PET), may be set as follows:

$$\frac{Δ E}{2} * A$$

(a ratio of the equivalent viscosity damping coefficients)/E*A (a ratio of the square root of spring constants)=2 or more
This may ensure the damping ratio ; of the alternator to be 0.5 or more in most vehicles.

In the present invention, a core wire material of the poly-V belt may be changed from polyester (PET) to polyethylene naphthalate (PEN), by which the damping ratio ζ of the alternator can be effectively increased to as large as 1.15 times.

### BRIEF DESCRIPTION OF THE DRAWINGS

In the accompanying drawings:

FIG. 1 is a cross section of an alternator related to a first embodiment of the present invention;

FIG. 2 shows a layout of an engine belt involving pulleys of individual auxiliary machines including the alternator and a crankshaft pulley of an engine, according to the first embodiment;

FIG. 3 is a front elevation of an alternator related to a second embodiment of the present invention;

FIG. 4 is a cross section of the alternator shown in FIG. 3;

FIG. 5 shows an engine layout involving auxiliary machines including a conventional alternator to be mounted on a vehicle;

FIG. 6 is a graph showing compliance (vibrational magnification) of individual auxiliary machines including the conventional alternator, relative to the number of revolutions of an engine;

FIG. 7 is a graph illustrating the relation between a damping ratio ζ and vibrational magnification;

FIG. 8 shows a relation between a Kₜₑₙₛᵢₗₑ (spring constant) and a Cₜₑₙₛᵢₗₑ (equivalent viscosity damping coefficient) in a single-body belt;

FIG. 9 shows a relation between a Kₜₒᵣₛᵢₒₙ and a Cₜₒᵣₛᵢₒₙ under a vehicle-mounted condition;

FIG. 10 is a graph for comparing the damping ration between the individual auxiliary machines including the alternator; and

FIG. 11 is a graph showing compliance (vibrational magnification) of individual auxiliary machines including the alternator of the present invention, relative to the number of revolutions of an engine.

### DETAILED DESCRIPTION OF THE PREFERRED EMBODIMENTS

Hereinafter are described various embodiments of an alternator according to the present invention with reference to the accompanying drawings. In each of the embodiments given below, a particular configuration is described for increasing the damping ratio ζ of an internal fan type of alternator for vehicles (simply, an alternator) up to 0.5 or more which is equal to or more than those of other auxiliary machines in the serpentine drive system fixed to an on-vehicle internal combustion engine. The damping ratio ζ is defined and calculated by the foregoing formula (5).

### First Embodiment

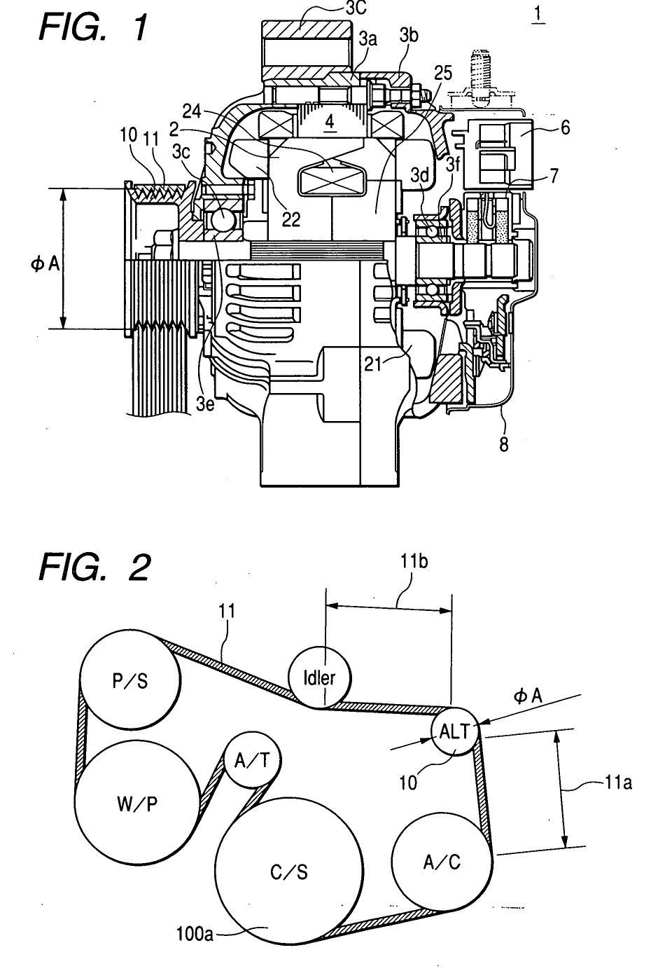

Referring to. FIGS. 1 to 2, a first embodiment will now be described.

An on-vehicle alternator 1 of the present embodiment shown in FIG. 1 is driven by an auxiliary drive system employing a serpentine is driving system. As shown in FIG. 2, this auxiliary drive system executes driving by allowing a single poly-V belt (hereinafter referred to as a belt) 11 to wrap pulleys of individual auxiliary machines including an engine crankshaft pulley (C/S) 100a on a driving side and a pulley (ALT) 10 of the alternator 1 on a driven side. Other than the alternator 1, the individual auxiliary machines include an air conditioner A/C, a water pump W/P and a power steering P/S. Note that pulleys for an auto tensioner A/T and an idler Idler are also wrapped by the belt 11.

As shown in FIG. 1, the alternator 1 of the present embodiment includes: a rotor 2 which is rotated and driven by the engine pulley 100a by way of the pulley 10 of the alternator 1 through the belt 11; internal Fans 21, 22 each fixed to either end of a pole core 25 for the rotor 2; and a stator 4 serving as an armature. The alternator 1 also includes a front frame 3a and a rear frame 3b which support the rotor 2 and the stator 4 through a pair of bearings 3c, 3d. The alternator 1 further includes a rectifier 5 which is connected to the stator 4 to convert an AC output to DC output, a brush device 7 for holding a brush for supplying field current to a field coil 24 of the rotor 2, and a regulator 9 for controlling output voltage. Additionally, the alternator 1 includes a connector case 6 having terminals for inputting/outputting electric signals between vehicles, and a protection cover 8 made of a resin and attached to an end face of the rear frame 3b to cover the rectifier 5, the regulator 9, the brush device 7 and the like.

Among the components enumerated above, those which constitute the moment of inertia for the alternator are four, which are the pulley 10, the rotor 2, inner rings 3e, 3f of the bearings 3c, 3d.

Among the contributors to the damping ratio ζ (i.e., pulley radii, belt span, moment of inertia, number of belt ribs, elasticity modulus of a single-body belt, and hysteresis loss of a single-body belt) described above, focus is put on pulley radii in the present embodiment, in particular, on a radius of the pulley 10. Hence an effective diameter ΦA of the pulley 10 of the alternator 1 is increased as will be described below, so that the damping ratio ζ of the alternator 1 is increased up to 0.5 or more.

Although the effective diameter ΦA of the pulley 10 is typically Φ70 mm or less, the present embodiment uses the effective diameter ΦA of Φ100 mm or More. In the alternator 1, this can ensure the damping ratio 4 of as large as 0.5 which is the same level as those of other auxiliary machines.

Thus, a ratio of the pulley 10 of the alternator 1 relative to the engine pulley 100a results in twice or less.

For example, if an effective diameter of the engine pulley 100a is Φ200 mm, and the effective diameter ΦA of the pulley 10 of the alternator 1 is Φ100 mm or more, the pulley ratio of the pulley 10 of the alternator 1 relative to the engine pulley 100a results in twice or less as shown below.
Φ200 mm/Φ100 mm or more≦2

Accordingly, the effective diameter ΦA of the pulley of the alternator 1 becomes Φ100 mm or more, so that the damping ratio ζ of the alternator 1 can be improved. Thus, in most vehicles, the damping ratio ζ of an alternator can be ensured to be 0.5 or more, the level of other auxiliary machines. Vibration can thus be significantly reduced in an alternator without the use of special components, such as a clutch or damper pulley.

### Second Embodiment

A second embodiment of the present invention is now described. Among the damping ratio contributors (i.e., pulley radii, belt span, moment of inertia, number of belt ribs, elasticity modulus of a single-body belt, and hysteresis loss of a single-body belt) described above, focus is put on the belt span in the present embodiment. Hence, span lengths 11a, 11b of the belt 11 (see FIG. 2) on both sides of the alternator 1 are reduced. In this case as well, the same effects as described above can be achieved.

A configuration for increasing the damping ratio ζ up to 0.5 or more in an on-vehicle alternator 1 of the present embodiment is described below.

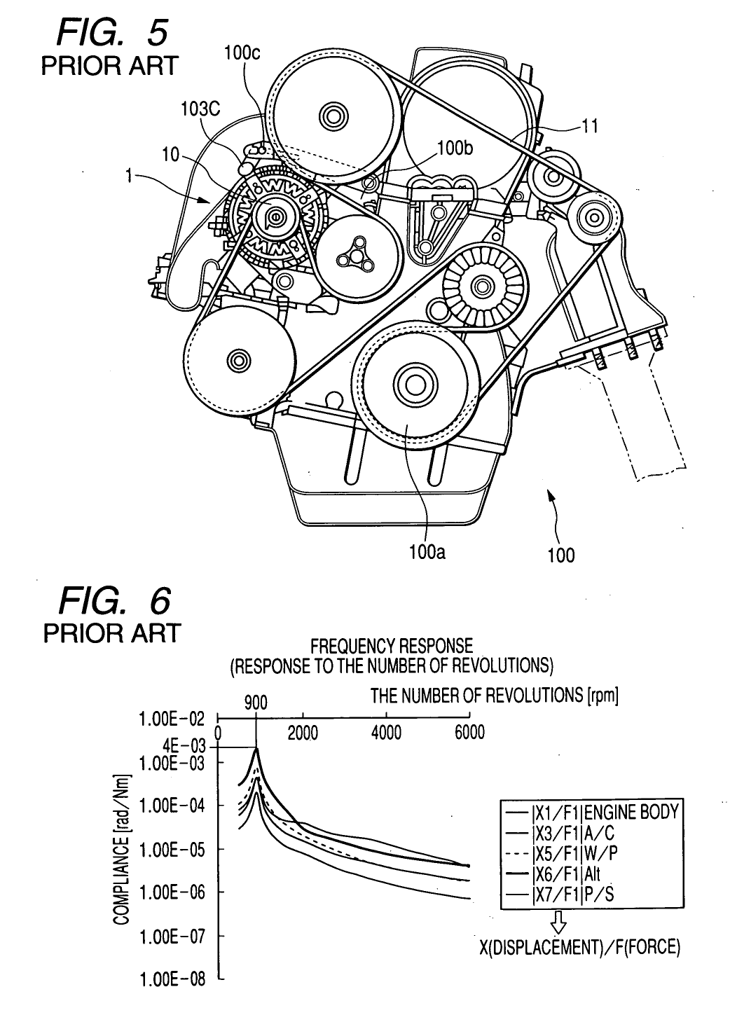

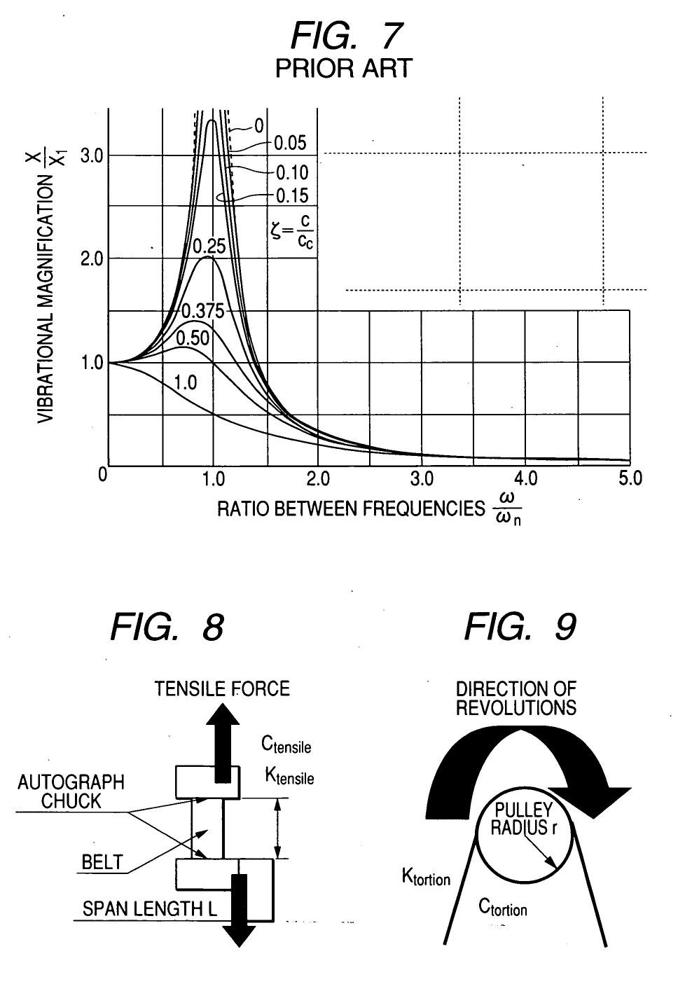

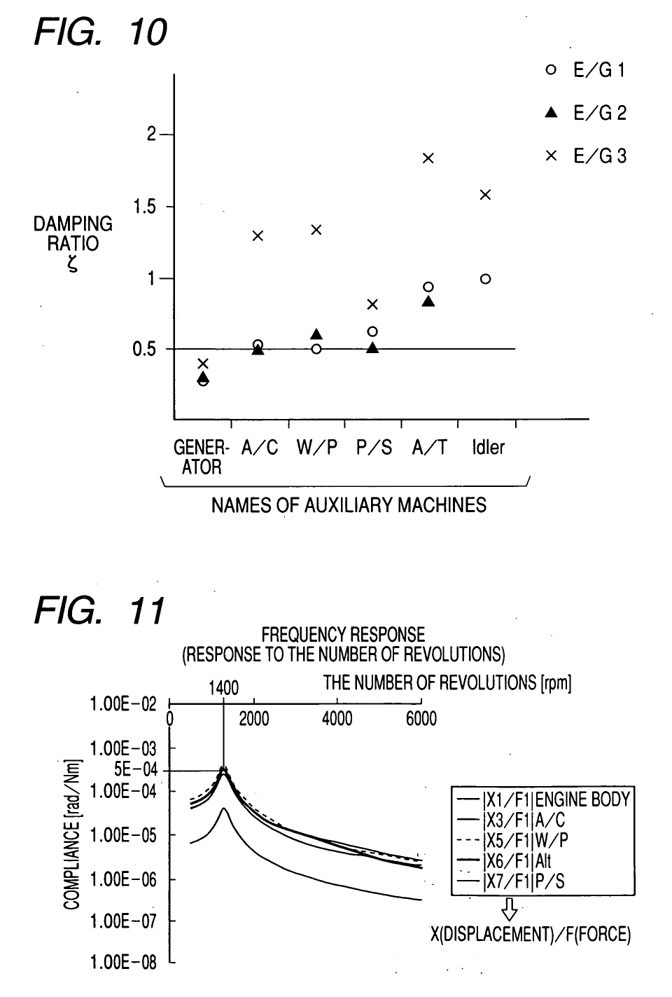

As shown in FIG. 5, in a conventional way of driving by using a three-axis drive system, a positional adjust stay 103c of the alternator 1 is threaded into a positional adjusting bar 100c protruding from an engine block 100b for tensile force adjustment of the belt 11. Therefore, when adjusting tensile force, the body of the alternator 1 isolates from the engine block bob. This necessitates the alternator 1 to have large span lengths 11a, 11b of the belt 11 on both sides thereof.

In multi-axis driving using a serpentine drive system of recent so trend, tensile force adjustment is performed by an auto tensioner, dispensing with the tensile force adjustment by the alternator 1. Nevertheless, the adjust stay 103c of the alternator 1 is still threaded into the adjust bar 100c protruding from the engine block 100b as in the three-axis drive system mentioned above, again making the span lengths 11a, 11b of the belt 11 large on both sides of the alternator 1.

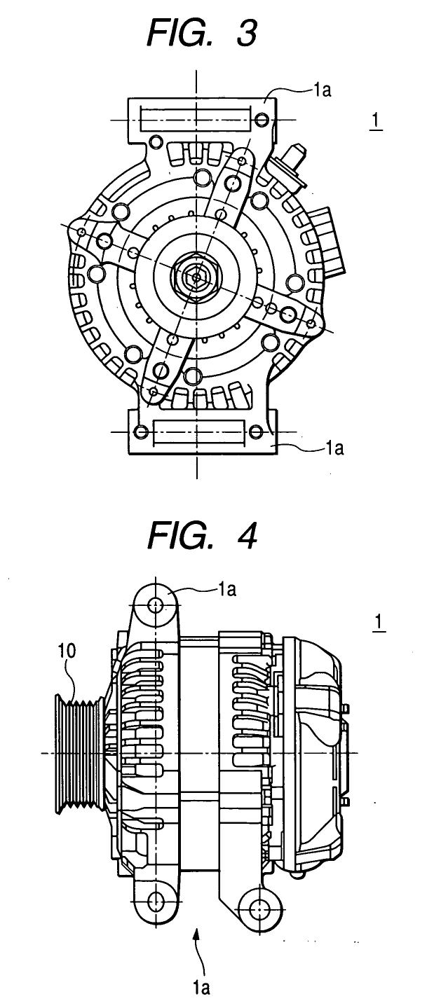

As shown in FIGS. 3 and 4, the present embodiment makes use of a side mounting system by providing a fixing portions (attaching portions) 1a to which the alternator 1 is fixed, while also utilizing the characteristics of the serpentine drive system, thereby reducing the span lengths 11a, 11b of the belt 11 on both sides of the alternator 1.

Specifically, the alternator 1 is attached to the engine block 100b through the fixing portion la, not through the adjust bar 100c as shown in FIG. 5, allowing the body of the alternator 1 to be positioned as close as possible to, but not interfering with the engine block 100b. This arrangement enables reduction of the span lengths 11a, 11b (see FIG. 2) of the belt 11 on both sides of the alternator 1, and increase of the damping ratio ζ of the alternator 1 up to 0.5 or more. Vibration can thus be significantly reduced in an alternator, as described above, without the use of special components, such as a clutch or damper pulley.

### Third Embodiment

A third embodiment of the present invention is described below. Among the damping ratio contributors (i.e., pulley radii, belt span, moment of inertia, number of belt ribs, elasticity modulus of a single-body belt, and hysteresis loss of a single-body belt) described above, focus is put on the elasticity modulus and the hysteresis loss of the single-body belt in the present embodiment. Hence, the spring constant is reduced and the equivalent viscosity damping coefficient is increased, both of which are essential physical properties of the belt 11. The damping ratio ζ of the alternator 1 is thus increased up to 0.5 or more as in the case described above.

The spring constant and the equivalent viscosity damping coefficient of the belt 11 are both determined by the qualities of the core wire. In the present embodiment therefore, the material of the core wire for the belt 11 is changed from polyester (PET), which is widely used currently, to polyethylene naphthalate (PEN). Although this causes the elasticity modulus of the belt to decrease to 0.77, the hysteresis loss of the belt increases to as large as 1.5 times that of the case where the core wire material is not changed. As a result, the damping ratio ζ of the alternator 1 increases to as large as 1.15 times.
0.77*1.5=1.15

Ratio of 1/E*A (elasticity modulus of the belt) . . . 0.77

Ratio of ΔE/2*A(hysteresis of the belt) . . . 1.5

The improvement of the core wire material thus enables the improvement of the damping ratio ζ.

Additionally, polyester (PET) constituting the following relation may be used:
Ratio of equivalent viscosity damping coefficient/Ratio of square root of spring constant=2 or more.

Typically, the damping ratio ζ of the alternator 1 is 0.25 or more, however, by changing the core wire material as described above, the damping ratio ζ of 0.5 or more can be ensured. Vibration can thus be significantly reduced in an alternator, as described above, without the use of special components, such as a clutch or damper pulley.

The present invention may be embodied in several other forms without departing from the spirit thereof. The embodiments and modifications described so far are therefore intended to be only illustrative and not restrictive, since the scope of the invention is defined by the appended claims rather than by the description preceding them. All changes that fall within the metes and bounds of the claims, or equivalents of such metes and bounds, are therefore intended to be embraced by the claims.

What is claimed is:

1. An on-vehicle alternator driven by an internal combustion engine of a vehicle, wherein the alternator is assembled as part of a serpentine drive system driven by a poly-V belt wrapping a crankshaft pulley of the engine and has a damping ratio of 0.5 or more.

2. The alternator of claim 1, wherein a pulley ratio which is defined as a ratio of an effective diameter of a pulley of the alternator relative to an effective diameter of the crankshaft pulley of the engine is set to 2 or less.

3. The alternator of claim 1, wherein the alternator is structured to be directly fixed to the engine as a side-mounted system.

4. The alternator of claim 1, wherein the poly-V belt has a core wire whose essential physical properties are a spring constant and an equivalent viscosity damping coefficient which are set with respect to an equivalent viscosity damping coefficient and a spring constant of polyester such that “a ratio of the equivalent viscosity damping coefficients/a ratio of square roots of the spring constants is 2 or more.”

5. The alternator of claim 1, wherein the poly-V belt has core wire made from polyethylene naphthalate.

6. The alternator of claim 1, wherein the damping ratio is set to be 0.5 or more on the basis of a formula of:
$$ζ = \frac{( A * E ) * {R}^{2} * \frac{\sqrt{Z}}{\sqrt{L}}}{\sqrt{J * ( \frac{A * Δ E}{2 * π * ϖ} )}}$$
where ω is frequency, J is a moment of inertia of each auxiliary machine, L is a combined span length of a belt at both sides of each auxiliary machine implemented in the serpentine drive system, the auxiliary machine including the alternator, R is a radius of a pulley of each auxiliary machine, Z is the number of ribs of the poly-V belt, E*A is an elasticity modulus of a single-body belt per rib, and ΔE/2 is a hysteresis loss (viscosity) of a belt per rib.

7. The alternator of claim 2, wherein the alternator is structured to be directly fixed to the engine as a side-mounted system.

8. The alternator of claim 7, wherein the poly-V belt has core wire made from polyethylene naphthalate.

9. The alternator of claim 8, wherein the damping ratio is set to be 0.5 or more on the basis of a formula of:
$$ζ = \frac{( A * E ) * {R}^{2} * \frac{\sqrt{Z}}{\sqrt{L}}}{\sqrt{J * ( \frac{A * Δ E}{2 * π * ϖ} )}}$$
where to is frequency, J is a moment of inertia of each auxiliary machine, L is a combined span length of a belt at both sides of each auxiliary machine implemented in the serpentine drive system, the auxiliary machine including the alternator, R is a radius of a pulley of each auxiliary machine, Z is the number of ribs of the poly-V belt, E*A is an elasticity modulus of a single-body belt per rib, and ΔE/2 is a hysteresis loss (viscosity) of a belt per rib.

10. The alternator of claim 2, wherein the poly-V belt has core wire made from polyethylene naphthalate.

11. The alternator of claim 10, wherein the damping ratio is set to be 0.5 or more on the basis of a formula of:
$$ζ = \frac{( A * E ) * {R}^{2} * \frac{\sqrt{Z}}{\sqrt{L}}}{\sqrt{J * ( \frac{A * Δ E}{2 * π * ϖ} )}}$$
where ω is frequency, J is a moment of inertia of each auxiliary machine, L is a combined span length of a belt at both sides of each auxiliary machine implemented in the serpentine drive system, the auxiliary machine including the alternator, R is a radius of a pulley of each auxiliary machine, Z is the number of ribs of the poly-V belt, E*A is an elasticity modulus of a single-body belt per rib, and ΔE/2 is a hysteresis loss (viscosity) of a belt per rib.

12. The alternator of claim 3, wherein the poly-V belt has core wire made from polyethylene naphthalate.

13. The alternator of claim 12, wherein the damping ratio is set to be 0.5 or more on the basis of a formula of:
$$ζ = \frac{( A * E ) * {R}^{2} * \frac{\sqrt{Z}}{\sqrt{L}}}{\sqrt{J * ( \frac{A * Δ E}{2 * π * ϖ} )}}$$
where ω is frequency, J is a moment of inertia of each auxiliary machine, L is a combined span length of a belt at both sides of each auxiliary machine implemented in the serpentine drive system, the auxiliary machine including the alternator, R is a radius of a pulley of each auxiliary machine, Z is the number of ribs of the poly-V belt, E*A is an elasticity modulus of a single-body belt per rib, and ΔE/2 is a hysteresis loss (viscosity) of a belt per rib.

14. The alternator of claim 5, wherein the damping ratio is set to be 0.5 or more on the basis of a formula of:
$$ζ = \frac{( A * E ) * {R}^{2} * \frac{\sqrt{Z}}{\sqrt{L}}}{\sqrt{J * ( \frac{A * Δ E}{2 * π * ϖ} )}}$$
where ω is frequency, J is a moment of inertia of each auxiliary machine, L is a combined span length of a belt at both sides of each auxiliary machine implemented in the serpentine drive system, the auxiliary machine including the alternator, R is a radius of a pulley of each auxiliary machine, Z is the number of ribs of the poly-V belt, E*A is an elasticity modulus of a single-body belt per rib, and ΔE/2 is a hysteresis loss (viscosity) of a belt per rib.
